(19) United States
(12) Patent Application Publication
(10) Pub. No.: US 2012/0240864 A1
(43) Pub. Date: Sep. 27, 2012

(54) BIRD FEEDER

(76) Inventor: Tom BARTAK, Center, NE (US)

(21) Appl. No.: 13/408,450

(22) Filed: Feb. 29, 2012

Related U.S. Application Data
(60) Provisional application No. 61/465,895, filed on Mar. 25, 2011.

(51) Int. Cl. A01K 39/014

(52) U.S. Cl. 119/52.2

(57) ABSTRACT

A bird feeder is disclosed wherein a plurality of spaced-apart metal mesh tubes extend upwardly from a tray to a bird seed reservoir. In one embodiment, the tubes are curved much like a barrel stave. In another embodiment, the tubes are elongated and straight cylinders. In another embodiment, the tubes are helical in shape. The tubes are spaced sufficiently apart to enable birds to pass therebetween so that the birds may gain access to the feed in the tubes from all sides of the tubes.

### CROSS-REFERENCE TO RELATED APPLICATION

This application claims the benefit of Provisional Application Serial No. 61/465,895, filed on March 25, 2011, entitled BIRD FEEDER.

### BACKGROUND OF THE INVENTION

1. Field of the Invention

This invention relates to a bird feeder and more particularly to a bird feeder including a plurality of spaced apart upstanding mesh tubes which are adapted to contain bird seed therein.

2. Description of the Related Art

Many types of bird feeders have been previously provided. See for example U.S. Pat. Nos. 6,047,661; 6,073,582; 7,185,605; 7,198,004; 7,302,911; 7,503,282; 7,506,611; and D621,557.

In the prior art bird feeders, the feeders normally include a central body portion which may be cylindrical, truncated conical-shaped, inverted truncated conical-shaped, etc. To the best of applicant's knowledge, no one has previously provided a bird feeder which is comprised of a plurality of spaced-apart mesh tubes such as disclosed herein.

### SUMMARY OF THE INVENTION

Three different types of bird feeders are disclosed herein. In a first embodiment, the bird feeder includes a generally horizontally disposed tray having an upper surface and a lower surface. A plurality of spaced-apart tubes having upper and lower ends, extend upwardly from the tray. The tubes are preferably comprised of a metal mesh material. A bird seed reservoir, having upper and lower ends, is positioned at the upper ends of the tubes. The lower end of the bird seed reservoir is in communication with the upper ends of the tubes so that bird seed in the reservoir may pass downwardly into the tubes. A roof is provided which extends over the upper end of the bird seed reservoir. The roof includes a bird seed fill opening so that bird seed may be placed into the bird seed reservoir.

In one embodiment, the tubes are elongated and cylindrical in configuration. In another embodiment, the tubes are helical in shape. In another embodiment, the tubes are arcuate. In each of the embodiments, the tubes are spaced-apart sufficiently so that birds may pass therebetween.

It is therefore a principal object of the invention to provide an improved bird feeder.

A further object of the invention is to provide a bird feeder which includes a plurality of spaced-apart metal mesh tubes which extend between a lower tray and an upper bird seed reservoir.

It is the further object of the invention to provide a bird feeder of a type described above wherein the metal mesh tubes are elongated and cylindrical in configuration.

It is a further object of the invention is to provide a bird feeder of a type described above wherein the tubes are helical in shape.

A further object of the invention is to provide a bird feeder of a type described above wherein the tubes are arcuate in configuration.

A further object of the invention is to provide a bird feeder of the type described wherein the tubes are spaced sufficiently apart so that birds may pass therebetween whereby the bird seed is accessible from all sides of the tubes.

These and other objects will be apparent to those skilled in the art.

### BRIEF DESCRIPTION OF THE DRAWINGS

FIG. 1 is a perspective view of a first embodiment of the bird feeder of this invention;

FIG. 2 is a top view of the bird feeder of FIG. 1;

FIG. 3 is a front view of the bird feeder of FIG. 1;

FIG. 4 is a typical side view of the bird feeder of FIG. 1;

FIG. 5 is a back view of the bird feeder of FIG. 1;

FIG. 6 is a bottom view of the bird feeder of FIG. 1;

FIG. 7 is a perspective view of a second embodiment of the bird feeder of this invention;

FIG. 8 is a top view of the bird feeder of FIG. 7;

FIG. 9 is a front view of the bird feeder of FIG. 7;

FIG. 10 is a typical side view of the bird feeder of FIG. 7;

FIG. 11 is a back view of the bird feeder of FIG. 7;

FIG. 12 is a bottom view of the bird feeder of FIG. 7;

FIG. 13 is a perspective view of a third embodiment of the bird feeder of this invention;

FIG. 14 is a top view of the bird feeder of FIG. 13;

FIG. 15 is a front view of the bird feeder of FIG. 13;

FIG. 16 is a typical side view of the bird feeder of FIG. 13;

FIG. 17 is a back view of the bird feeder of FIG. 13; and

FIG. 18 is a bottom view of the bird feeder of FIG. 13.

### DESCRIPTION OF THE PREFERRED EMBODIMENT

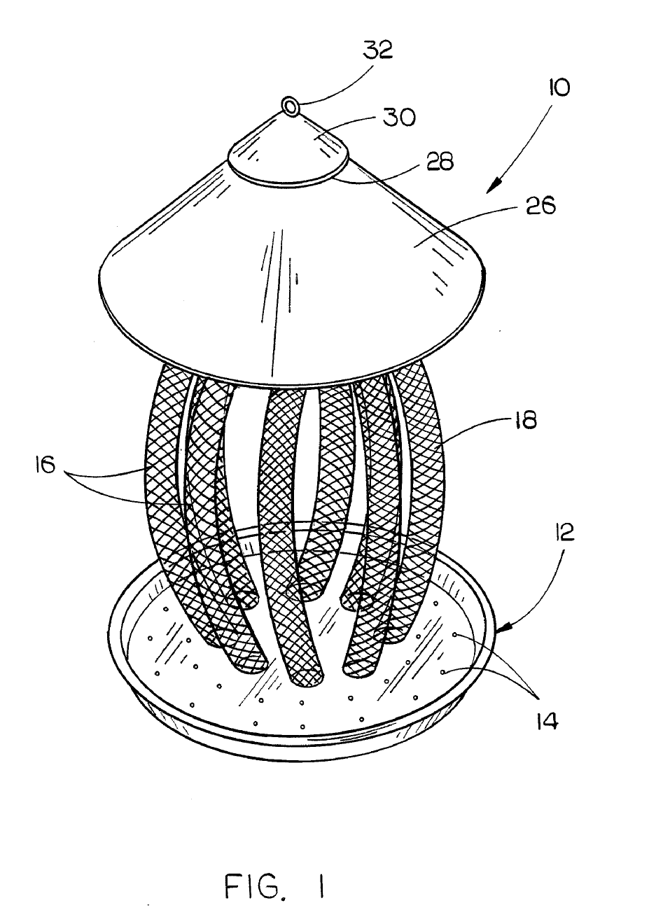

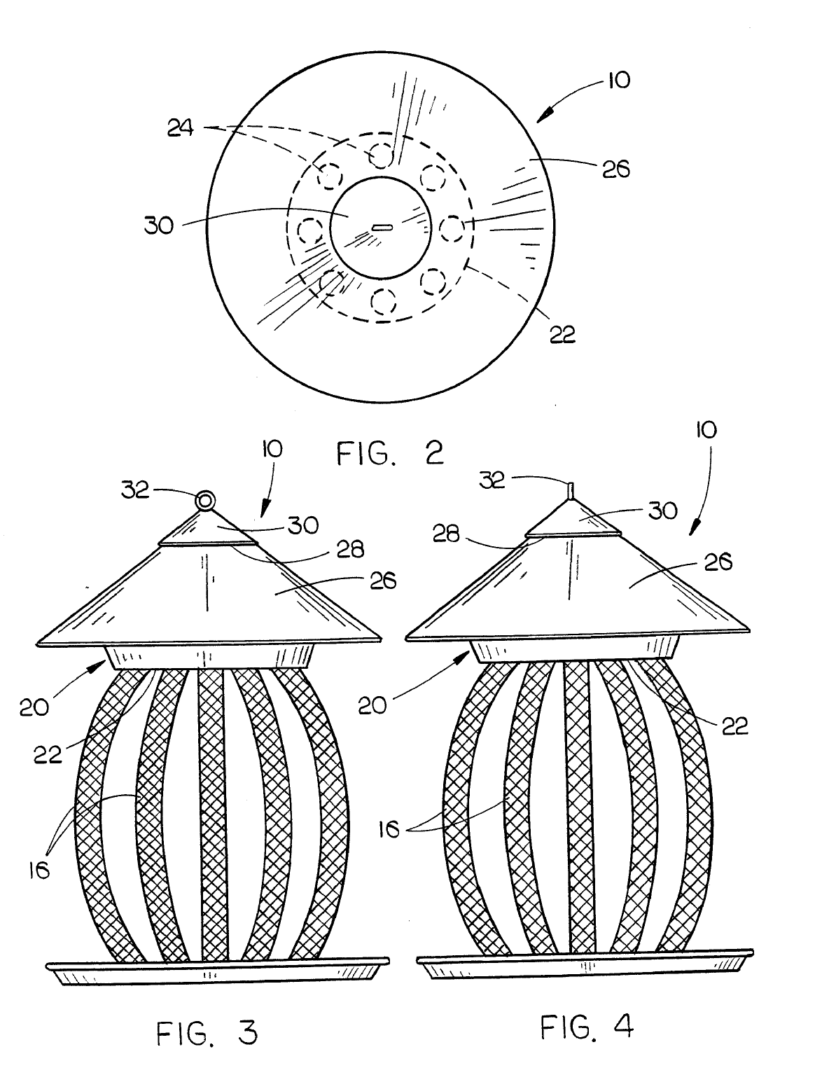

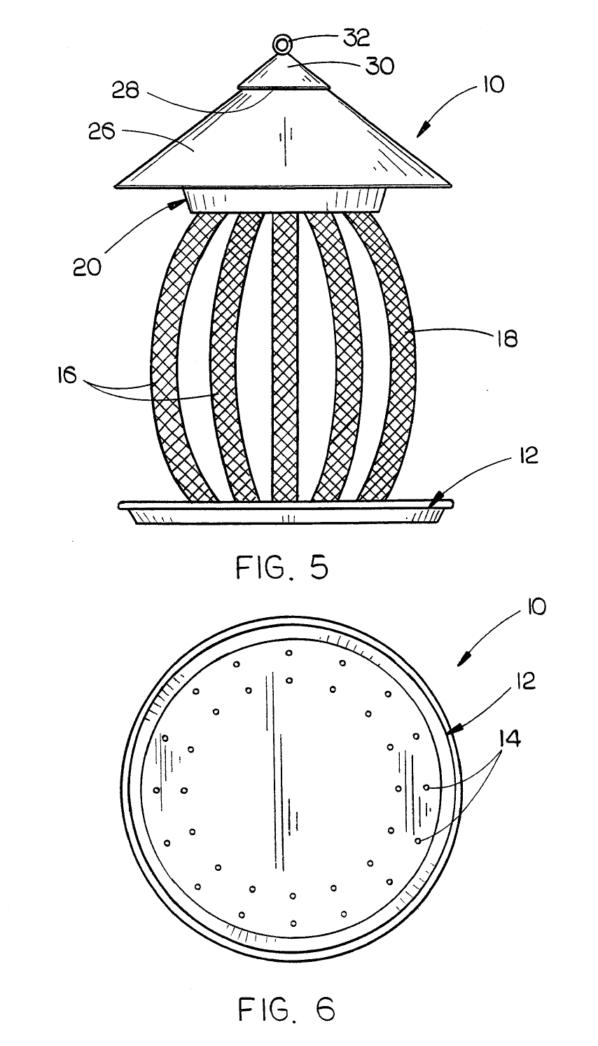

In FIGS. 1-6 a first embodiment of the bird feeder of this invention is shown and which is designated by the reference numeral 10. Bird feeder 10 includes a disc-shaped tray 12 having draining openings 14 formed therein. A plurality of spaced-apart metal mesh tubes 16 have their lower ends secured to tray 12 by any convenient means. The metal mesh tubes define feed openings 18 therein to enable birds to gain access to the bird seeds therein. As seen in FIGS. 1-6, the tubes 16 are curved like a barrel stave.

The numeral 20 refers to a bird seed reservoir having a bottom wall 22 which has spaced-apart openings 24 formed therein which communicate with the upper ends of the tubes 16 so that bird seeds in reservoir 20 may pass downwardly into the tubes 16. A roof 26 is provided at the upper end of reservoir 20 as seen in the drawings. Roof 26 has a fill opening 28 formed therein which is closed by a removable cover or lid 30. Hanger 32 is secured to roof 26 to enable the bird feeder to be suspended by a support such as a pole, tree branch, etc.

The tubes 16 are spaced sufficiently apart so that birds may pass therebetween which enables the birds to feed from all sides of each of the tubes 16.

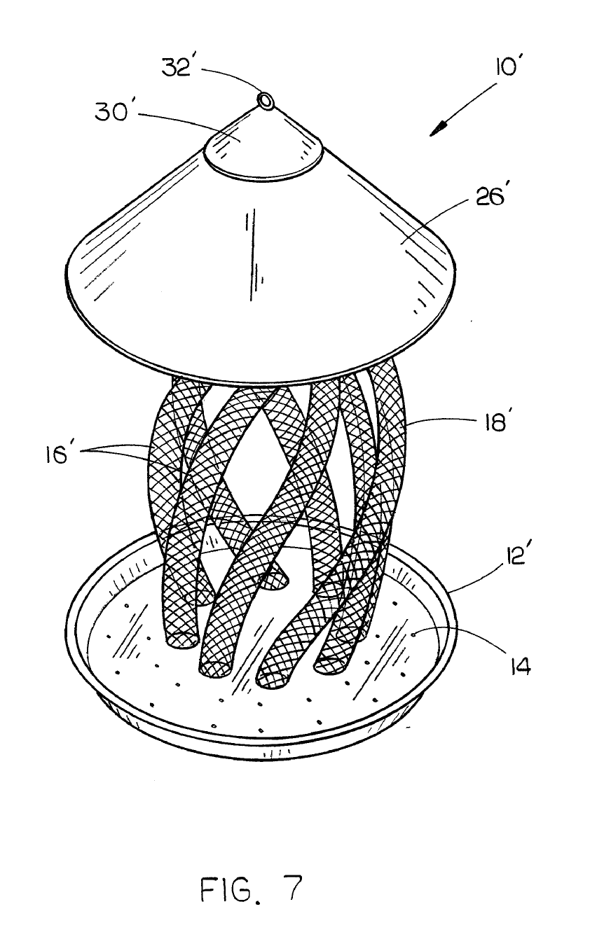

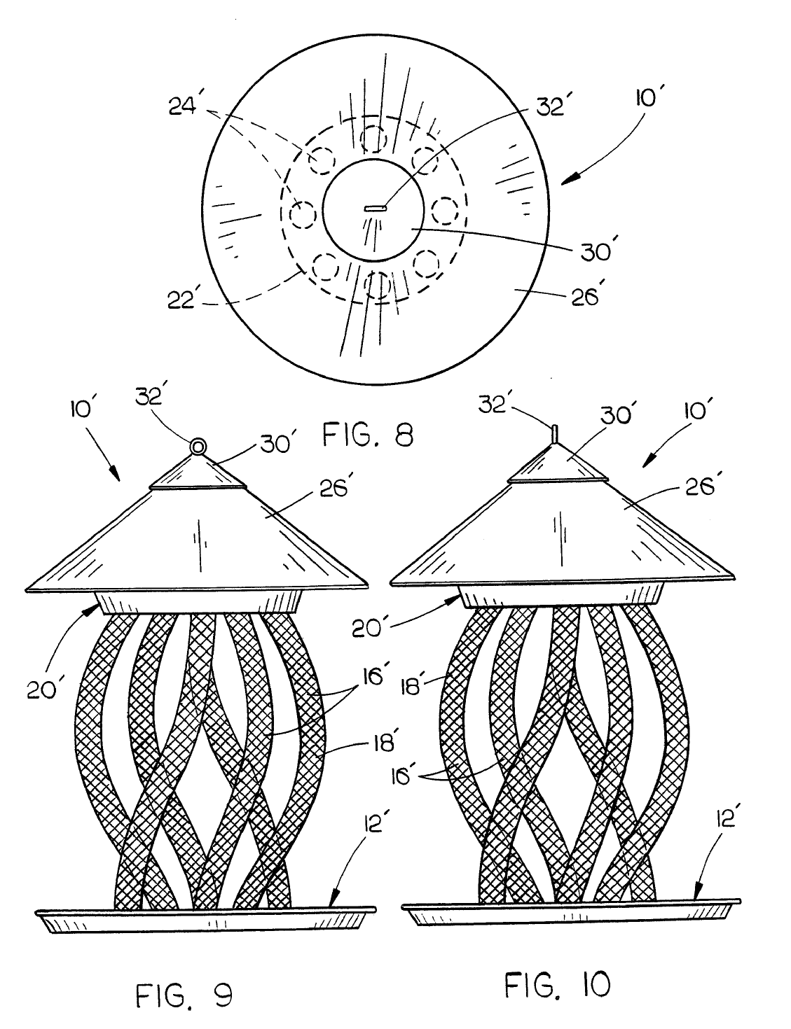

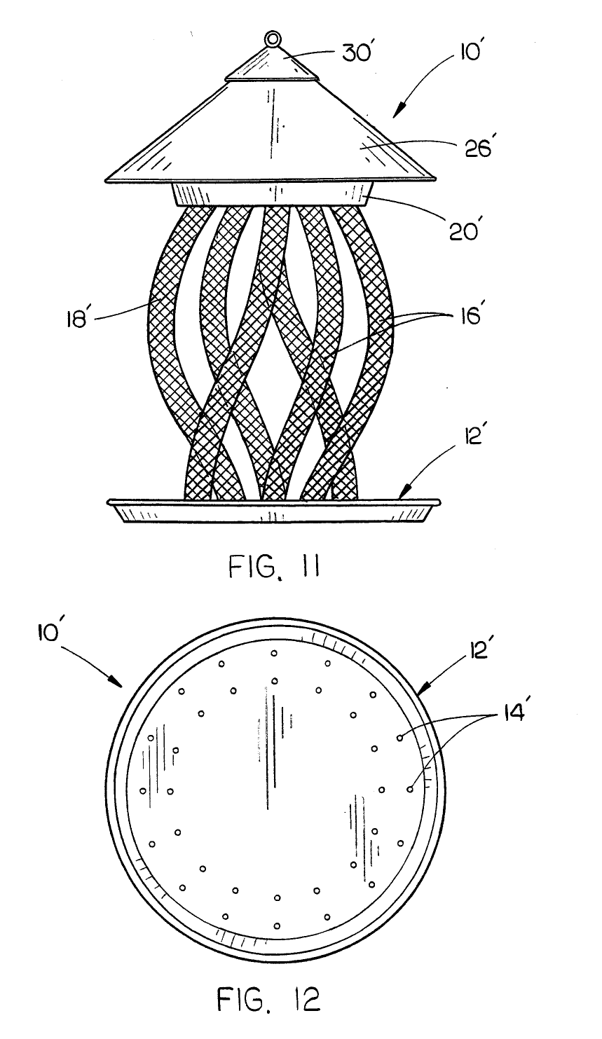

In FIGS. 7-12, a second embodiment of the bird feeder of this invention is shown and is designated by the reference numeral 10′. Bird feeder 10′ includes a disc-shaped tray 12′ having drain openings 14′ formed therein. A plurality of spaced-apart metal mesh tubes 16′ have their lower ends secured to tray 12′ by any convenient means. The metal mesh tubes 16′ define feed openings 18′ therein to enable birds to gain access to the bird seeds therein. As seen in FIGS. 7-12, the tubes 16′ are helical in shape so that the bird feeder may rotate or spin when subjected to wind such like helical wind chimes.

The numeral 20′ refers to a bird seed reservoir having a bottom wall 22′ which has spaced-apart openings 24′ formed therein which communicate with the upper ends of the tubes 16′ so that bird seeds in reservoir 20′ may pass downwardly into the tube 16′. A roof 26′ is provided at the upper end of reservoir 20′ as seen in the drawings. Roof 26′ has a fill opening 28′ formed therein which is closed by a removable cover or lid 30′. Hanger 32′ is secured to roof 26′ to enable the bird feeder to be suspended by a support such as a pole, tree branch, etc.

The tubes 16′ are spaced sufficiently apart so that birds may pass therebetween which enables the birds to feed from all sides of each of the tubes 16′.

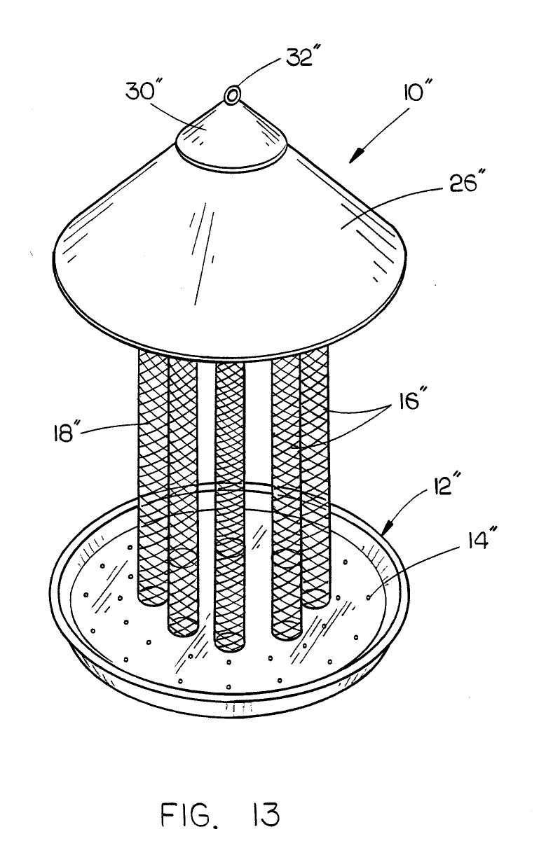

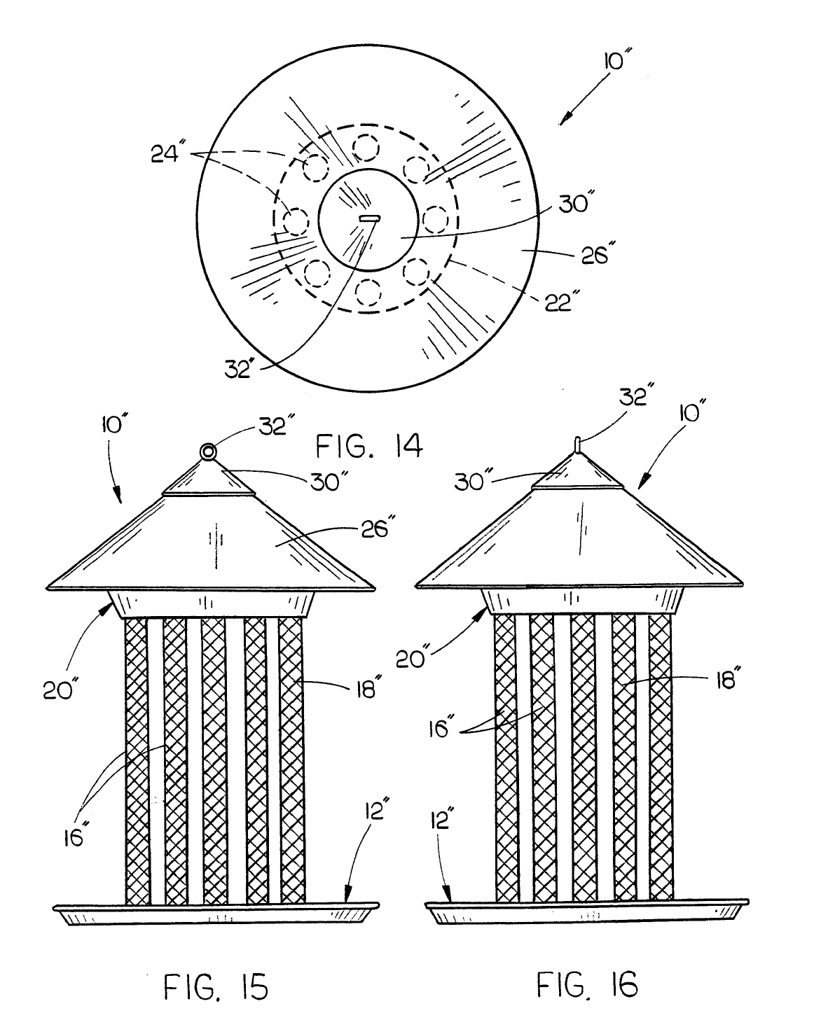

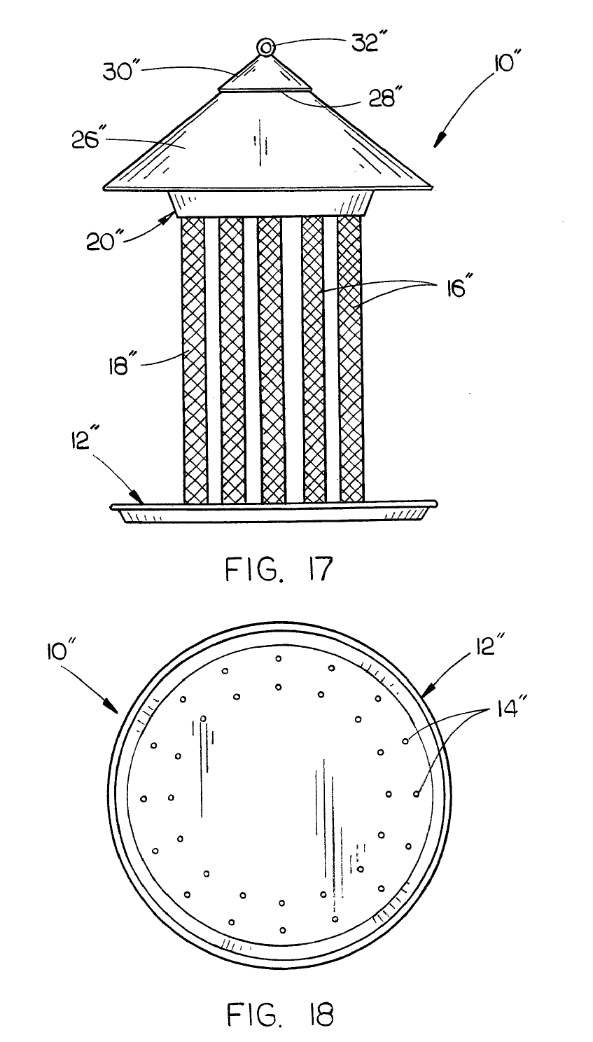

In FIGS. 13-18, a third embodiment of the bird feeder of this invention is shown and which is designated by the reference numeral 10″. Bird feeder 10″ includes a disc-shaped tray 12″ having drain openings 14″ formed therein. A plurality of spaced-apart metal mesh tubes 16″ have their lower ends secured to tray 12″ by any convenient means. The metal mesh tubes 16″ define feed openings 18″ therein to enable birds to gain access to the bird seeds therein. As seen in FIGS. 13-18, tubes 16″ are straight.

The numeral 20″ refers to a bird seed reservoir having a bottom wall 22″ which has spaced-apart openings 24″ formed therein which communicate with the upper ends of the tubes 16″ so that bird seeds in reservoir 20″ may pass downwardly into the tubes 16″. A roof 26″ is provided at the upper end of reservoir 20″ as seen in the drawings. Roof 26″ has a fill opening 28″ formed therein which is closed by a removable cover or lid 30″. Hanger 32″ is secured to roof 26″ to enable the bird feeder 10″ to be suspended by a support such as a pole, tree branch, etc.

The tubes 16″ are spaced sufficiently apart so that birds may pass therebetween which enables the birds to feed from all sides of each of the tubes 16″.

It can therefore be seen that the bird feeder of this invention accomplishes at least all of its stated objectives.

1. A bird feeder comprises:
a generally horizontally disposed tray having an upper surface and a lower surface;
a plurality of spaced-apart tubes, having upper and lower ends, secured to and extending upwardly from said tray;
said tubes being comprised of a mesh material;
a bird seed reservoir, having upper and lower ends, positioned at the upper ends of said tubes;
said lower end of said bird seed reservoir being in communication with said upper ends of said tubes whereby bird seed in said bird seed reservoir may pass downwardly into said tubes;
a roof at the upper end of said bird seed reservoir;
said roof includes a bird seed fill opening whereby bird seed may be placed into said bird seed reservoir.

2. The bird feeder of claim 1 wherein said tubes have an elongated cylindrical configuration.

3. The bird feeder of claim 1 wherein said tubes are helical in shape.

4. The bird feeder of claim 1 wherein said tubes are arcuate.

5. The bird feeder of claim 1 wherein said tubes are spaced-apart sufficiently so that birds may pass therebetween.

6. The bird feeder of claim 1 wherein said mesh material is comprised of metal.

7. The bird feeder of claim 1 wherein said tray has drain openings formed therein.

8. A bird feeder comprising:
a generally horizontally disposed tray having an upper surface and a lower surface;
a plurality of spaced-apart tubes, having upper and lower ends, secured to and extending upwardly from said tray;
said tubes being comprised of a mesh material;
a bird seed reservoir, having upper and lower ends, positioned at the upper ends of said tubes;
said lower end of said bird seed reservoir being in communication with said upper ends of said tubes whereby bird seed in said bird seed reservoir may pass downwardly into said tubes;
a cover at the upper end of said bird seed reservoir;
said cover including a bird seed fill opening whereby bird seed may be placed into said bird seed reservoir.

9. The bird feeder of claim 8 wherein said tubes have an elongated cylindrical configuration.

10. The bird feeder of claim 8 wherein said tubes are helical in shape.

11. The bird feeder of claim 8 wherein said tubes are arcuate.

12. The bird feeder of claim 8 wherein said tubes are spaced-apart sufficiently so that birds may pass therebetween.

13. The bird feeder of claim 8 wherein said mesh material is comprised of metal.

14. The bird feeder of claim 8 wherein said tray has drain openings formed therein.
